(19) United States
(12) Patent Application Publication
(10) Pub. No.: US 2010/0267979 A1
(43) Pub. Date: Oct. 21, 2010

(54) METHOD FOR PRODUCTION OF ORGANOSILICON COMPOUNDS BY HYDROSILYLATION IN IONIC LIQUIDS

(75) Inventors: Andreas Bauer, Simbach (DE); Thomas Frey, Burghausen (DE); Norbert Hofmann, Nuernbert (DE); Peter Schulz, Erlangen (DE); Peter Wasserscheid, Erlangen (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/306,050

(22) PCT Filed: Jun. 21, 2007
(86) PCT No.: PCT/EP2007/056210

§ 371 Date: Mar. 3, 2009

(30) Foreign Application Priority Data
Jun. 27, 2006 (DE) 10 2006 029 430.0

(51) Int. Cl. C07F 7/08

(52) U.S. Cl. 556/479

(57) ABSTRACT

Organosilanes are prepared by hydrosilylation of unsaturated organic compounds by monomeric silanes containing at least one silicon bonded hydrogen, in a process wherein an ionic liquid containing a hydrosilylation catalyst is present as one phase, and the reactants are present in at least a second phase.

The invention relates to a process for preparing organosilicon compounds by hydrosilylation in ionic liquids.

The preparation of organosilicon compounds is carried by the Müller-Rochow synthesis in the prior art. The functionalized organosilanes are of great economic importance, in particular halogen-substituted organosilanes, since they serve as starting materials for the production of many important products, for example silicones, bonding agents, hydrophobicizing agents and building protection compositions. However, this direct synthesis is not equally well suited for all silanes. The preparation of deficiency silanes is difficult in this way and can be achieved only in poor yields.

One possible way of preparing deficiency silanes is to convert silanes which are easy to prepare (excess silanes) into deficiency silanes by means of a ligand exchange reaction. This reaction is carried out using ionic liquids in a two-phase system for ligand exchange of organochlorosilanes with other organochlorosilanes and is described, for example, in DE 101 57 198 A1. In this process, a ligand exchange reaction occurs on a silicon atom, in which an organosilane is disproportionated in the presence of an ionic liquid which is a halide, metal halide or transition metal halide of organic nitrogen or phosphorus compounds or reacted with another organosilane to effect ligand exchange.

For the purposes of the present invention, ionic liquids are salts or mixtures of salts in general whose melting points are below 100° C., as described, for example, in P. Wasserscheid, W. Keim, Angew. Chem. 2000, 112, 3926. Salts of this type known in the literature comprise anions such as halostannates, haloaluminates, hexafluorophosphates, tetrafluoroborates, alkylsulfates, alkylsulfonates or arylsulfonates, dialkylphosphates, thiocyanates or dicyanamides combined with substituted ammonium, phosphonium, imidazolium, pyridinium, pyrazolium, triazolium, picolinium or pyrrolidinium cations. Numerous publications have described the use of ionic liquids as solvents for transition metal-catalyzed reactions, for example T. Welton, Chem. Rev. 1999, 99, 2071, and P. Wasserscheid, W. Keim, Angew. Chem., 2000, 112, 3926, and P. Wasserscheid, T. Welton (Eds.) “Ionic Liquids in Synthesis”, 2003, Wiley-VCH, Weinheim, pp. 213-257. Some of these publications and the studies cited there describe notable improvements in the catalyst properties of transition metal catalysts if these are used as solutions in ionic liquids rather than in organic solvents in the catalytic reactions. These improvements are also of considerable industrial relevance and are reflected, for example, in a significantly improved catalyst separability and catalyst reuse, a significantly increased catalyst stability, a significantly increased reactivity or a significantly improved selectivity of the reaction catalyzed. In general, ionic liquids offer the opportunity of matching relevant solvent properties in a stepwise fashion by targeted structural variation to a specific intended application.

The hydrosilylation of 1-alkenes, is known to be catalyzed by metal complexes of the platinum group, as described, for example, in J. Marciniec, “Comprehensive Handbook on Hydrosilylation”, Pergamon Press, New York 1992. Platinum complexes in particular, for example the “Speier catalyst” [H₂PtCl₆*6H₂O] and the “Karstedt solution”, viz. a complex of [H₂PtCl₆*6H₂O] and vinyl-substituted disiloxanes, are known to be very active catalysts. Studies by Lewis have also shown that the use of some anhydrous platinum compounds, for example dicyclooctadienyl platinum ([Pt(cod)₂]), results in formation of platinum colloids which are likewise highly active catalysts for hydrosilylation, as described, for example, in the article L. N. Lewis, N. Lewis, J. Am. Chem. Soc. 1986, 108, 7728.

Carrying out the hydrosilylation reaction as a liquid-liquid two-phase reaction requires a system which comprises a polar solvent and a nonpolar solvent and in which the two solvents have a miscibility gap. The systems cyclohexane/propene as nonpolar phase and cyclohexane/propylene carbonate as polar phase have been published in A. Behr, N. Toslu, Chem. Eng. Technol. 2000, 23, 2. This system makes it possible to carry out, for example, the hydrosilylation of Ω-undecenoic acid by means of triethoxysilane, with the product accumulating in the nonpolar phase and thus being able to be separated off easily from the catalyst and the starting materials which remain in the polar phase. The separation in this specific case works only because of the very nonpolar character of the unsaturated fatty acid used.

The use of ionic liquids as catalyst phase in the Pt-catalyzed hydrosilylation of terminal olefins by means of SiH-functionalized polymethylsiloxanes is also known and is described, for example, in B. Weyershausen, K. Hell, U. Hesse, Green. Chem., 2005, 7, 283. According to this publication, the use of ionic liquids as polar phase leads to demixing of catalyst phase and the nonpolar products, so that the products themselves form the second nonpolar phase. Separation of the products from the polar IL/catalyst/starting material phase can be achieved in this way without further work-up by distillation. For the specific case of the hydrosilylation of terminal olefins by means of SiH-functionalized polydimethylsiloxanes, it has been able to be shown that the prerequisites for industrial utilization of the liquid-liquid two-phase reaction, namely complete solubility of the Pt catalyst in the ionic liquid and the miscibility gap between ionic liquid and the products, can be achieved by targeted design of the anions and cations of the ionic liquid. Hydrosilylation by means of SiH-functionalized polydimethylsiloxanes is not restricted only to terminal olefins but can, as disclosed in the patent document EP 1 382 630 A1, be extended to all compounds containing C—C multiple bonds.

In recent years, the “supported ionic liquid phase” (=SILP) catalyst technology has become established as a novel concept for carrying out transition metal-catalyzed reactions in ionic liquids very efficiently. It was first described by Mehnert for the example of Rh-catalyzed hydroformylation and hydrogenation reactions in the following documents: C. P. Mehnert, R. A. Cook, N. C. Dispenziere, M. Afeworki, J. Am. Chem. Soc. 2002, 124 12932-12933 and C. P. Mehnert, E. J. Mozeleski, R. A. Cook, Chem. Commun. 2002, 3010-3011. In the SILP catalyst technology, the solution of a transition metal complex in an ionic liquid is applied to a usually highly porous support by physisorption or chemical reaction and the solid catalyst obtained in this way is brought into contact with the reactants in a gas-phase or liquid-phase reaction. This technology represents a new way of combining the advantages of classical homogeneous catalysis with those of classical heterogeneous catalysis. The application of a film having a thickness of only a few nanometers of ionic catalyst solution to a porous solid makes a high specific surface area of ionic catalyst solution available for the reaction without introduction of mechanical energy into the reactants. The catalyst remains largely in homogeneous solution. The technology also offers, due to the uncomplicated catalyst retention, a very simple route to continuous processes, for example as described in A. Riisager, P. Wasserscheid, R. van Hal, R. Fehrmann, J. Catal. 2003, 219, 252. As the article by A. Riisager, R. Fehrmann, S. Flicker, R. van Hal, M. Haumann, P. Wasserscheid, Angew. Chem., Int. Ed. 2005, 44, 815-819, shows in spectroscopic and kinetic studies for at least the Rh-catalyzed hydroformylation, the transition metal catalyst is still present in dissolved form in the immobilized liquid film. Owing to possible interactions of the active surface groups of the porous support with the transition metal catalyst in the support film which is only a few nanometers thick, the successful use of the SILP technology is not obvious to a person skilled in the art. Further known applications of the SILP technology are carrying out the Pd-catalyzed Heck reaction and Rh-, Pd- or Zn-catalyzed hydroamination with the aid of supported, ionic catalyst solutions. This is described, for example, in H. Hagiwara, Y. Sugawara, K. Isobe, T. Hoshi, T. Suzuki, Org. Lett. 2004, 6, 2325 and S. Breitenlechner, M. Fleck, T. E. Müller, A. Suppan, J. Mol. Catal. A: Chem. 2004, 214, 175.

In the patent document WO 02/098560 A1, Mehnert discloses the production of SILP catalysts by reaction of an ionic liquid having a reactive side chain with a siliceous support. For the preparation of the ionic liquid having a reactive side chain, hydrosilylation is mentioned as a method. The reaction disclosed is a method of introducing the reactive side chain into ionic liquids which are to be bound to siliceous supports by formation of a covalent bond.

It was therefore an object of the invention to provide a process for preparing silanes by hydrosilylation, which proceeds very selectively and thus leads to high yields of the desired silanes.

This object has been achieved by the process of the invention for preparing silanes by hydrosilylation, which is characterized in that a transition metal complex which is present as a solution in an ionic liquid during the hydrosilylation reaction is used as catalyst for the reaction.

An advantage of the novel process according to the present invention is the technical possibility of separating off and recirculating the catalyst in the liquid-liquid multiphase system or in variants in which the ionic catalyst solution is supported on solids. In addition, a significant selectivity improvement in the silane synthesis compared to the known synthetic methods is achieved in many cases.

In the process of the invention, nonpolymeric compounds of the general formula (1)

HₐSiR_{b} (1),

are reacted with alkenes of the general formula 2

R⁸R⁹C═CR¹⁰R¹¹ (2),

where
the radicals R are each, independently of one another, H or a monovalent Si—C-bonded, unsubstituted or halogen-substituted C₁-C₁₈-hydrocarbon, chlorine or C₁-C₁₈-alkoxy radical,
a is 1, 2 or 3,
b is 4-a,
R⁸, R⁹, R¹⁰ and R¹¹ are each, independently of one another, H or a monovalent unsubstituted or F-, Cl-, OR-, NR₂-, CN- or NCO-substituted C₁-C₁₈-hydrocarbon, chlorine, fluorine or C₁-C₁₈-alkoxy radical, where in each case 2 radicals from among R⁸, R⁹, R¹⁰ and R¹¹ together with the carbon atoms to which they are bound can form a cyclic radical, in the hydrosilylation.

As nonpolymeric compounds which are reacted in the process of the invention, preference is given to compounds of the general formula (3)

R_{c}H_{d}SiCl_{4-c-d} (3)

where
R is as defined above and
c can be 0, 1, 2, 3 or 4 and
d can be 1, 2 or 3.

It was very surprising that this reaction is successful. According to the document DE 101 57 198 A1, this would not have been expected since in the presence of an ionic liquid which is a halide, metal halide or transition metal halide of organic nitrogen or phosphorus compounds, the selectivity of such a hydrosilylation should not lead to the desired product of the hydrosilylation in sufficiently high selectivity as a result of the disproportionation of silane which would be expected to occur in parallel or the ligand exchange between two organosilanes which would be expected to occur in parallel. Such a superimposition of hydrosilylation, disproportionation and ligand exchange reaction should thus make the preparative use of a hydrosilylation of nonpolymeric compounds which bear one or more H—Si function(s) by means of unsaturated compounds with the aid of ionic catalyst solutions in a liquid-liquid multiphase system impossible in industry.

The reaction according to the invention of compounds of the formula (1) which bear one or more H—Si function(s) is preferably carried out using alkenes which can contain chlorine, alkoxy or amino functions in addition to carbon and hydrogen.

In the prior art, there is the additional problem that the hydrosilylation reaction is known to be accompanied by the transfer of chlorine, alkoxy or amino functions to the hydrosilylation catalyst or the compounds of the formula (1) used, which restricts the yield which can be achieved in the hydrosilylation process according to the prior art so that, in particular, satisfactory industrial solutions for the reaction of such mixtures have hitherto been lacking. In view of the industrial importance of these chlorine-, alkoxy- or amino-functionalized hydrosilylation products, the solution according to the invention to this problem has considerable economic potential.

The present process according to the invention provides an unexpected technical solution based on the discovery that the solution of a transition metal complex used as hydrosilylation catalyst in an ionic liquid surprisingly does catalyze a hydrosilylation of nonpolymeric Si—H compounds in a multiphase reaction system in a selective fashion. The process of the present invention additionally offers a technically reliable opportunity for separating off and recirculating the catalyst in the liquid-liquid two-phase system. Only small changes in the activity and selectivity of the ionic catalyst solution are observed after multiple recirculation of the ionic liquid. In the preferred variants of the process of the invention described below, the changes are particularly small.

In a particularly preferred embodiment of the process of the present invention, the compounds HSiCl₃, HSiCl₂Me, HSiClMe₂, HSiCl₂Et and HSiClEt₂, HSi(OMe)₃, HSi(OEt)₃, HSi(OMe)₂Me, HSi(OEt)₂Me, HSi(OMe)Me₂ and HSi(OEt)Me₂ are used as Si—H compounds of the formula (3).

In a further preferred embodiment of the process of the present invention, propene, allyl chloride, acetylene, ethylene, isobutylene, cyclopentene, cyclohexene and 1-hexadecene are used as alkenes.

In a particularly preferred embodiment of the process, HSiCl₃ and HSiMeCl₂ are used as Si—H compound and allyl chloride is used as alkene component.

In a preferred embodiment of the process of the present invention, complexes of platinum, iridium or rhodium are used as catalyst. Particular preference is given to the complexes of platinum, in particular the complexes PtCl₄ and H₂PtCl₆.

In a preferred embodiment of the process of the present invention, an ionic liquid of the general formula (4)

[A]⁺[Y]⁻ (4)

where
[Y]⁻ is an anion selected from the group consisting of [tetrakis(3,5-bis(trifluoromethyl)phenyl)borate], ([BARF]), tetraphenylborate ([BF₄]⁻), hexafluorophosphate ([PF₆]⁻), trispentafluoroethyltrifluorophosphate ([P(C₂F₅)₃F₃]⁻), hexafluoroantimonate ([SbF₆]⁻), hexafluoroarsenate ([AsF₆]⁻), fluorosulfonate, [R′—COO]⁻, [R′—SO₃]⁻, [R′—O—SO₃]⁻, [R′₂—PO₄]⁻ or [(R′—SO₂)₂N]⁻, where R′ is a linear or branched, aliphatic or alicyclic alkyl radical containing from 1 to 12 carbon atoms, a C₅-C₁₈-aryl radical or a C5-C18-aryl-C1-C6-alkyl radical whose hydrogen atoms may be completely or partly replaced by fluorine atoms, and
[A]⁺ is a cation selected from the group consisting of ammonium cations of the general formula (5)

[NR¹R²R³R₄]⁺ (5),
phosphonium cations of the general formula (6)

[PR¹R²R³R₄]⁺ (6),
imidazolium cations of the general formula (7)

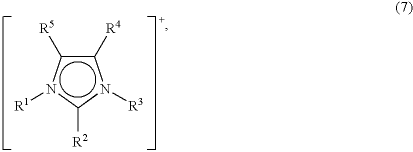

pyridinium cations of the general formula (8)

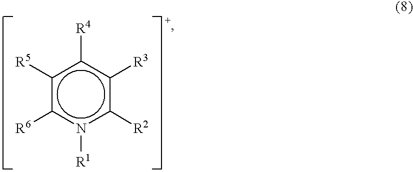

pyrazolium cations of the general formula (9)

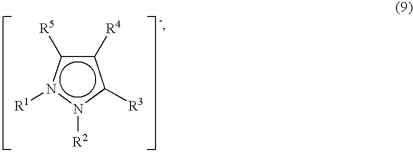

triazolium cations of the general formula (10)

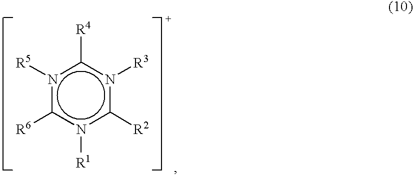

picolinium cations of the general formula (11)

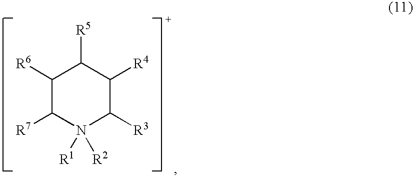

and
pyrrolidinium cations of the general formula (12)

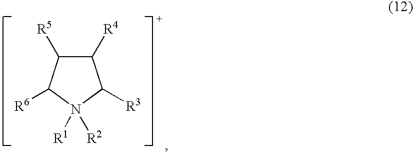

where the radicals R¹⁻⁷ are, in each case independently of one another, organic radicals having 1-20 carbon atoms,
is used as ionic liquid.

The radicals R¹⁻⁷ are preferably aliphatic, cycloaliphatic, aromatic, araliphatic or oligoether groups.

Aliphatic groups are straight-chain or branched hydrocarbon radicals having from one to twenty carbon atoms, where heteroatoms such as oxygen, nitrogen or sulfur atoms being able to be present in the chain.

The radicals R¹⁻⁷ can be saturated or have one or more double or triple bonds which can be conjugated or in isolated positions in the chain.

Examples of aliphatic groups are hydrocarbon groups having from one to 14 carbon atoms, for example methyl, ethyl, n-propyl, isopropyl, n-butyl, sec-butyl, tertbutyl, n-pentyl, n-hexyl, n-octyl or n-decyl.

Examples of cycloaliphatic groups are cyclic hydrocarbon radicals which have from three to twenty carbon atoms and can contain ring heteroatoms such as oxygen, nitrogen or sulfur atoms. The cycloaliphatic groups can also be saturated or have one or more double or triple bonds which can be conjugated or present in isolated positions in the ring. Saturated cycloaliphatic groups, in particular saturated aliphatic hydrocarbons, which have from 5 to 8 ring carbons, preferably five or six ring carbons, are preferred.

Aromatic groups, carbocyclic aromatic groups or heterocyclic aromatic groups can have from six to twenty two carbon atoms. Examples of suitable aromatic groups are phenyl, naphthyl and anthracyl.

Oligoether groups are groups of the general formula (13)

—[(CH₂)ₓ—O]_{y}—R′″ (13),

where
x and y are, independently of one another, numbers in the range from 1 to 250 and
R′″ is an aliphatic, cycloaliphatic, aromatic or araliphatic group.

In a further preferred embodiment, an ionic liquid whose cations [A]⁺ cannot form a C—H bond to a low-valence metal complex, metal complexes having N-heterocyclic carbene ligands by deprotination or oxidative addition is used. As cations of the ionic liquid used, particular preference is given to N-alkylpyridinium and 1,2,3-trialkylimidazolium cations.

These cations [A]⁺ are, in a particularly preferred embodiment of the present invention, combined with, in particular, the anion [Y]⁻ [(CF₃SO₂)₂N]⁻, so that the following ionic liquids are particularly preferred for use in the process of the invention:
1-ethylpyridinium bistrifluoromethylsulfonylimide
1-butylpyridinium bistrifluoromethylsulfonylimide
1-hexylpyridinium bistrifluoromethylsulfonylimide
1-ethyl-3-methylpyridinium bistrifluoromethylsulfonylimide
1-butyl-3-methylpyridinium bistrifluoromethylsulfonylimide
1-hexyl-3-methylpyridinium bistrifluoromethylsulfonylimide
1-ethyl-4-methylpyridinium bistrifluoromethylsulfonylimide
1-butyl-4-methylpyridinium bistrifluoromethylsulfonylimide
1-hexyl-4-methylpyridinium bistrifluoromethylsulfonylimide
1-ethyl-2,3-dimethylimidazolium bistrifluoromethylsulfonylimide
1-butyl-2,3-dimethylimidazolium bistrifluoromethylsulfonylimide
1-hexyl-2,3-dimethylimidazolium bistrifluoromethylsulfonylimide

The process of the invention is carried out as a two-phase reaction in which the catalyst can be used as a liquid phase and the reaction products can be present as a liquid phase or gas phase.

In a preferred embodiment of the process, the transition metal complex is dissolved in the ionic liquid and is contacted in the reactor with a nonmiscible phase which contains the reaction product at the reactor outlet, so that the ionic catalyst solution is continuously separated off by phase separation in the process and recirculated to the reactor.

In a further variant of the process, a film of the ionic catalyst solution is applied to a support material and the catalyst is in this form brought into contact with the reaction mixture in a gas-phase reaction or a liquid-phase reaction. This application of the SILP technology known for other reactions to the hydrosilylation of nonpolymeric SI—H compounds of the formula (1) by means of alkenes of the formula (2) was surprisingly very successful since this process variant represents the first successful use of Pt-containing SILP catalysts. Furthermore, it is surprising that, despite the known sensitivity of the hydrosilylation reaction to water, the reaction can be carried out successfully using supported ionic catalyst solutions. The lack of deactivation of the sensitive transition metal catalyst or the possible impairment of the product selectivity by interactions of the support with the catalyst could also not readily have been foreseen.

The process described can be carried out either at atmospheric pressure or under superatmospheric pressure. The process is preferably carried out at a pressure of up to 200 bar, particularly preferably at a pressure of up to 20 bar.

Finally, the fact that an increased selectivity to the desired product of the hydrosilylation reaction is observed for the particularly preferred variants of the process of the present invention is particularly surprising and of very great economic importance. This effect is attributed to the specific solvent environment of the ionic liquid.

### EXAMPLES

The abbreviations used below have the meanings shown here:
cat catalyst
IL ionic liquid
HV high vacuum
silane: AC molar ratio of silane to allyl chloride
Pt conc platinum concentration
X1 conversion of allyl chloride
X2 conversion of trichlorosilane
S 1 selectivity to product: mole of product/mole of product+mole of tetrachlorosilane
S 2 selectivity to prosilane: mole of prosilane/mole of prosilane+mole of tetrachlorosilane
Y yield
“TOF” turnover frequency
tetra tetrachlorosilane
prosilane propyltrichlorosilane
[EMMIM] 1-ethyl-2,3-dimethylimidazolium
[BTA] bistrifluoromethanesulfonylimide
ICP-AES Inductively Coupled Plasma-Atomic Emission Spectrometry

### Example 1

### Atmospheric-Pressure Hydrosilylation Experiment Using Ionic Liquid for the Example of the Synthesis of 3-chloropropyltrichlorosilane (According to the Invention)

About 10 ml of the ionic liquid 1-ethyl-2,3-dimethylimidazolium bistrifluoromethanesulfonylimide are placed in a baked flask (100-250 ml). This ionic liquid is predried at 80° C. (external temperature regulation) under HV for one hour while stirring continually (magnetic stirrer). When the ionic liquid is approximately free of moisture, 17 mg of platinum tetrachloride (corresponding to 1500 ppmn) are weighed in. The ionic catalyst solution is after-dried at 80° C. under reduced pressure for one hour after the addition of the catalyst. The three-neck flask is subsequently connected under a continual protective gas stream to the reflux condenser and provided with a dropping funnel. The third connection of the flask is connected to a contact thermometer for monitoring the internal temperature. When the apparatus has been closed in a gastight manner, all newly connected components are dried in HV. The other reactants (3-chloropropyltrichlorosilane: 5.6 g; allyl chloride: 5.6 g and trichlorosilane: 12.5 g) are then weighed in under a protective gas atmosphere. An initial charge of the product reduces the vapor pressures of the starting materials. To weigh in all the reactants (3-chloropropyltrichlorosilane, allyl chloride and trichlorosilane), they are placed in syringes and weighed and the syringes are weighed again after introduction of the starting materials into the dropping funnel. The reaction temperature of 100° C. is set and regulated at the thermostat. The temperature of the low-temperature condenser (−20° C.) is produced by means of a cryostat. When the reaction temperature has been reached, the reactants are carefully added from the dropping funnel (addition rate: 5-40 drops/min). If the temperature drops to more than 10° C. below the reaction temperature, the addition is interrupted until the reaction temperature has returned to the set value. When the addition is complete, the mixture is stirred for another 60 minutes to ensure complete reaction of the reactants. Ionic liquid and products are then cooled in an ice bath. The contents of the three-neck flask are taken up into a syringe for phase separation, the organic phase (top) and ionic catalyst solution are separated and dispensed into separate vessels. A small amount of the products dissolves in the ionic catalyst solution and can, if desired, be taken off under reduced pressure. The organic phase is analyzed by means of gas chromatography. The amount of platinum which has migrated into the product phase is determined by means of ICP-AES.

### Comparative Example 1

### Atmospheric-Pressure Hydrosilylation Experiment without Ionic Liquid (not According to the Invention)

A three-neck flask (100-250 ml) is provided with a dropping funnel and contact thermometer for monitoring the internal temperature and dried under high vacuum. 6.0 g of the product 3-chloropropyltrichlorosilane are subsequently placed under a protective gas atmosphere in the three-neck flask. About 8.5 mg (corresponding to 600 ppmn of Pt) of the organic catalyst complex (solution of PtCl4 in 1-dodecene) are dissolved therein at 80° C. (external temperature regulation) while stirring continually (magnetic stirrer). The other reactants (allyl chloride: 6.40 g and trichlorosilane: 13.9 g) are then weighed under a protective gas atmosphere into the dropping funnel. To weigh in all the reactants (3-chloropropyltrichlorosilane, allyl chloride and trichlorosilane), they are placed in syringes and weighed and the syringes are weighed again after introduction of the starting materials into the dropping funnel. Particular attention has to be paid here to the correct ratio of the reactants. The reaction temperature of 100° C. is set and regulated at the thermostat. The temperature of the low-temperature condenser (−20° C.) is produced by means of a cryostat. When the reaction temperature has been reached, the reactants are carefully added from the dropping funnel (addition rate: 5-40 drops/min). If the temperature drops to more than 10° C. below the reaction temperature, the addition is interrupted until the reaction temperature has returned to the set value. When the addition is complete, the mixture is stirred for another 60 minutes to ensure complete reaction of the reactants. After the reaction, the organic products are analyzed by means of gas chromatography.

Table 1 shows the results of example 1 and comparative example 1.

TABLE 1

| | | Example 1 | Comparative example 1 |
|---|---|---|---|
| Cat | | PtCl₄ | organic catalyst |
| | | | solution |
| IL | | [EMMIM] [BTA] | without IL |
| Initial charge | | IL, cat, GF15 | cat, GF15 |
| Silane: AC | | 1.25: 1 | 1.25: 1 |
| Pt conc. | | 1500 ppm | 600 ppm |
| X1 | [mol %] | 100 | 100 |
| X2 | [mol %] | 92 | 95 |
| S1 | [mol %] | 82 | 77 |
| S2 | [mol %] | 44 | 29 |
| Y (product) | [mol %] | 82 | 73 |
| “TOF” | [1/h] | 1425 | 1180 |
| Y (tetra) | [mol %] | 14 | 19 |
| Y (prosilane) | [mol %] | 11 | 8 |

### Example 2

### Hydrosilylation Experiment Using Ionic Liquid Under Superatmospheric Pressure (According to the Invention)

About 10 ml of the ionic liquid 1-ethyl-2,3-dimethylimidazolium bistrifluoromethanesulfonylimide are placed in a laboratory autoclave which has been dried in high vacuum and flooded with argon. 3.5 mg of platinum tetrachloride (corresponding to 300 ppmn) are weighed into the approximately moisture-free ionic liquid. The ionic catalyst solution is after-dried at 100° C. (monitoring of the internal temperature) under reduced pressure for one hour after the addition of the catalyst.

The other reactants (3-chloropropyltrichlorosilane: 11.63 g; allyl chloride: 6.7 g and trichlorosilane: 13.4 g) are then weighed under a protective gas atmosphere into a connected dropping funnel. To weigh in all the reactants (3-chloropropyltrichlorosilane, allyl chloride and trichlorosilane), they are placed in syringes and weighed and the syringes are weighed again after introduction of the starting materials into the dropping funnel. Particular attention has to be paid here to the correct ratio of the reactants. After the reactor has been charged, it is placed under the reaction pressure of 12 bar by means of argon. The reaction temperature of 100° C. is set at the heating sleeve and regulated internally. When the reaction temperature has been reached, the reactants are added from the dropping funnel. After the reaction is complete (time: about two hours), the autoclave is carefully cooled to room temperature in an ice bath and subsequently opened under a flow or argon. The contents are taken up into a syringe for phase separation, the organic phase (top) and ionic catalyst solution are separated and dispensed into separate vessels. A small amount of the products dissolves in the ionic catalyst solution and can, if desired, be taken off under reduced pressure. The organic phase is analyzed by means of gas chromatography. The amount of platinum which has migrated into the product phase is determined by means of ICP-AES.

### Comparative Example 2

### Hydrosilylation Experiment without Ionic Liquid Under Superatmospheric Pressure (not According to the Invention)

About 6.5 g of 3-chloropropyltrichlorosilane are placed in a laboratory autoclave which has been dried in high vacuum and flooded with argon. 8.5 mg (corresponding to 600 ppmn of Pt) of the organic catalyst complex (solution of PtCl₄ in 1-dodecene) are weighed into the approximately moisture-free liquid.

The other reactants (allyl chloride: 6.0 g and trichlorosilane: 13 g) are then weighed under a protective gas atmosphere into a connected dropping funnel. To weigh in all the reactants (3-chloropropyltrichlorosilane, allyl chloride and trichlorosilane), they are placed in syringes and weighed and the syringes are weighed again after introduction of the starting materials into the dropping funnel. Particular attention has to be paid here to the correct ratio of the reactants. After the reactor has been charged, it is placed under the reaction pressure of 12 bar by means of argon. The reaction temperature of 100° C. is set at the heating sleeve and regulated internally. When the reaction temperature has been reached, the reactants are added from the dropping funnel. After the reaction is complete (time: about two hours), the autoclave is carefully cooled to room temperature in an ice bath and subsequently opened under a flow of argon. The contents are taken up into a syringe for phase separation, the organic phase (top) and ionic catalyst solution are separated and dispensed into separate vessels. A small amount of the products dissolves in the ionic catalyst solution and can, if desired, be taken off under reduced pressure. The organic phase is analyzed by means of gas chromatography.

Table 2 shows the results of example 2 and comparative example 2.

TABLE 2

| | | Example 2 | Comparative example 2 |
|---|---|---|---|
| Cat | | PtCl₄ | organic catalyst |
| | | | solution |
| IL | | [EMMIM] [BTA] | without IL |
| Initial charge | | IL, cat, | cat, product |
| | | product | |
| Silane: AC | | 1.25: 1 | 1.25: 1 |
| Pt conc. | | 300 ppm | 600 ppm |
| X1 | [mol %] | 98 | 98 |
| X2 | [mol %] | 97 | 99 |
| S1 | [mol %] | 74 | 73 |
| S2 | [mol %] | 48 | 49 |
| Y (GF15) | [mol %] | 52 | 65 |
| “TOF” | [1/h] | 2214 | 1467 |
| Y (tetra) | [mol %] | 16 | 19 |
| Y (prosilane) | [mol %] | 15 | 18 |

### Example 3

### Atmospheric-Pressure Hydrosilylation Experiment Using Ionic Liquid for the Example of the Synthesis of 3-Chloropropyltrichlorosilane (According to the Invention)

About 10 ml of the ionic liquid 1-ethyl-2,3-dimethylimidazolium bistrifluoromethanesulfonylimide are placed in a baked flask (100-250 ml). This ionic liquid is predried at 80° C. (external temperature regulation) under HV for one hour while stirring continually (magnetic stirrer). When the ionic liquid is approximately free of moisture, 0.62 mg of platinum tetrachloride (corresponding to 55 ppmn) is weighed in. The ionic catalyst solution is after-dried at 80° C. under reduced pressure for one hour after the addition of the catalyst. The three-neck flask is subsequently connected under a continual protective gas stream to the reflux condenser and provided with a dropping funnel. The third connection of the flask is connected to a contact thermometer for monitoring the internal temperature. When the apparatus has been closed in a gastight manner, all newly connected components are dried in HV. The other reactants (3-chloropropyltrichlorosilane: 5.6 g; allyl chloride: 5.6 g and trichlorosilane: 12.5 g) are then weighed in under a protective gas atmosphere. An initial charge of the product reduces the vapor pressures of the starting materials. To weigh in all the reactants (3-chloropropyltrichlorosilane, allyl chloride and trichlorosilane), they are placed in syringes and weighed and the syringes are weighed again after introduction of the starting materials into the dropping funnel. The reaction temperature of 100° C. is set and regulated at the thermostat. The temperature of the low-temperature condenser (−20° C.) is produced by means of a cryostat. When the reaction temperature has been reached, the reactants are carefully added from the dropping funnel (addition rate: 5-40 drops/min). If the temperature drops to more than 10° C. below the reaction temperature, the addition is interrupted until the reaction temperature has returned to the set value. When the addition is complete, the mixture is stirred for another 60 minutes to ensure complete reaction of the reactants.

Ionic liquid and products are then cooled in an ice bath. The contents of the three-neck flask are taken up into a syringe for phase separation, the organic phase (top) and ionic catalyst solution are separated and dispensed into separate vessels. A small amount of the products dissolves in the ionic catalyst solution and can, if desired, be taken off under reduced pressure. The organic phase is analyzed by means of gas chromatography. The amount of platinum which has migrated into the product phase is determined by means of ICP-AES.

### Example 4

### Hydrosilylation Using the SILP Technology (According to the Invention)

A granular silica (about 5 g) having a particle size distribution of from 0.2 to 0.5 mm is used as support material. Before application of the ionic liquid, the support is calcined at 450° C. for a number of hours and placed under protective gas while still hot. The ionic liquid 1-ethyl-3-methylimidazolium bistrifluoromethanesulfonylimide (1.0 g) is already laden with the catalyst (PtCl₄: 0.7 mg; corresponding to 55 ppmn) and is dissolved in a 10-fold excess of methanol. The support material is combined with the IL-methanol solution and stirred until a homogeneous distribution can be ensured. In the final step, the methanol is carefully removed under reduced pressure and at a moderately elevated temperature (about 50° C.). This SILP catalyst is subsequently dried at 80° C. (external temperature regulation) in HV for one hour while stirring continually (magnetic stirrer).

A three-neck flask (100-250 ml) is provided with a dropping funnel, reflux condenser and contact thermometer for monitoring the internal temperature. A heatable glass frit for accommodating the catalyst is installed between the reflux condenser and the three-neck flask. The entire apparatus including SILP catalyst is dried in high vacuum. When the apparatus has cooled down, the dropping funnel is charged with 6.3 g of allyl chloride and 11.7 g of trichlorosilane under a continual protective gas stream. To weigh in all the reactants (allyl chloride and trichlorosilane), they are placed in syringes and weighed and the syringes are weighed again after introduction of the starting materials into the dropping funnel. Particular attention has to be paid here to the correct ratio of the reactants. The reaction temperature of 100° C. is set and regulated via the heating tape of the glass frit. The temperature of the low-temperature condenser (−20° C.) is produced by means of a cryostat. The three-neck flask serves as vaporizer for the starting materials and is heated to 100° C. by means of an oil bath. When the reaction temperature has been reached, the reactants are carefully added from the dropping funnel (addition rate: 5-40 drops/min). If the temperature drops to more than 10° C. below the reaction temperature, the addition is interrupted until the reaction temperature has returned to the set value. After the reaction, the organic products are analyzed by means of gas chromatography. Residues of organic material adhering to the SILP catalyst can be separated off by means of reduced pressure or dry cyclohexane. The amount of platinum which has migrated into the product phase is determined by means of ICP-AES.

Table 3 shows a comparison of examples 3 and 4.

TABLE 3

| | | Example 3 | Example 4 |
|---|---|---|---|
| Cat | | PtCl₄ | PtCl₄ |
| IL | | EMMIM BTA | EMMIM BTA |
| Special feature | | | SILP |
| Initial charge | | IL, cat | IL, cat |
| Silane: AC | | 1.1 | 1.1 |
| Pt conc. | | 55 ppm | 55 ppm |
| X1 | [mol %] | 95 | 85 |
| X2 | [mol %] | 91 | 89 |
| S total | [mol %] | 76 | 72 |
| S1 | [mol %] | 77 | 73 |
| S2 | [mol %] | 4 | 4 |
| Y (GF15) | [mol %] | 64 | 70 |
| “TOF” | [1/h] | 5347 | 2184 |
| Y (tetra) | [mol %] | 18 | 25 |
| Y (prosilane) | [mol %] | 1 | 1 |

### Example 5

### Recycling Experiments (According to the Invention)

About 10 ml of the ionic liquid 1-ethyl-3-methylimidazolium bistrifluoromethanesulfonylimide are placed in a baked flask (100-250 ml). This ionic liquid is predried at 80° C. (external temperature regulation) under HV for one hour while stirring continually (magnetic stirrer). When the ionic liquid is approximately free of moisture, 0.7 mg of platinum tetrachloride (corresponding to 55 ppmn) is weighed in. The ionic catalyst solution is after-dried at 80° C. under reduced pressure for one hour after the addition of the catalyst. The three-neck flask is subsequently connected under a continual protective gas stream to the reflux condenser and provided with a dropping funnel. The third connection of the flask is connected to a contact thermometer for monitoring the internal temperature. Ground glass joints which do not have to be handled during the reaction or preparation are additionally secured with plastic film. When the apparatus has been closed in a gastight manner, all newly connected components are dried in HV. The other reactants (allyl chloride: 6.4 g and trichlorosilane: 11.7 g) are then weighed in under a protective gas atmosphere. To weigh in all the reactants (allyl chloride and trichlorosilane), they are placed in syringes and weighed and the syringes are weighed again after introduction of the starting materials into the dropping funnel. Particular attention has to be paid here to the correct ratio of the reactants. The reaction temperature of 100° C. is set and regulated at the thermostat. The temperature of the low-temperature condenser (−20° C.) is produced by means of a cryostat. When the reaction temperature has been reached, the reactants are carefully added from the dropping funnel (addition rate: 5-40 drops/min). If the temperature drops to more than 10° C. below the reaction temperature, the addition is interrupted until the reaction temperature has returned to the set value. When the addition is complete, the mixture is stirred for another 60 minutes to ensure complete reaction of the reactants. Ionic liquid and products are then cooled in an ice bath. The contents of the three-neck flask are taken up into a syringe for phase separation, the organic phase (top) and ionic catalyst solution are separated and dispensed into separate vessels. A small amount of the products dissolves in the ionic catalyst solution and can, if desired, be taken off under reduced pressure. The organic phase is analyzed by means of gas chromatography. The amount of platinum which has migrated into the product phase is determined by means of ICP-AES.

The ionic liquid is, without work-up, reintroduced into the apparatus and reused in the reaction in the manner described above (pretreatment and amount of the reactants used). Attention has to be paid here to a satisfactory protective gas technique. Drying of the ionic liquid under reduced pressure can be dispensed with here. Such recycling can be carried out successfully for at least four steps.

Table 4 shows the results after the respective recycle. It can be seen here that the reuse of the ionic catalyst solution leads to good results even after the third recycle.

TABLE 4

| | | EMIM | EMIM | EMIM | EMIM |
|---|---|---|---|---|---|
| IL | | BTA | BTA | BTA | BTA |
| Special feature | | | recycle 1 | recycle 2 | recycle 3 |
| Initial charge | | IL, | IL, cat | IL, cat | IL, cat |
| | | cat | | | |
| Silane:AC | | 1:1 | 1:1 | 1:1 | 1:1 |
| Pt conc. | | 55 ppm | 55 ppm | 55 ppm | 55 ppm |
| X1 | [mol %] | 97 | 95 | 97 | 95 |
| X2 | [mol %] | 98 | 94 | 98 | 91 |
| S1 | [mol %] | 86 | 80 | 88 | 77 |
| S2 | [mol %] | 3 | 9 | 18 | 4 |
| Y (product) | [mol %] | 67 | 63 | 66 | 64 |
| “TOF” | [1/h] | 5223 | 4600 | 5048 | 5347 |
| Y (tetra) | [mol %] | 11 | 14 | 9 | 18 |
| Y (prosilane) | [mol %] | 0 | 1 | 2 | 1 |

1.-7. (canceled)

8. A process for preparing silanes by hydrosilylation of nonpolymeric Si—H compounds, comprising reacting nonpolymeric Si—H compounds of the formula (1) in the presence of a transition metal complex which is present as a solution in an ionic liquid during the hydrosilylation reaction as catalyst for the reaction,
HₐSiR_{b} (1)
with alkenes of the formula (2)
R⁸R⁹C═CR¹⁰R¹¹ (2),
where
the radicals R are each, independently of one another, H or a monovalent Si—C-bonded, unsubstituted or halogen-substituted C₁-C₁₈-hydrocarbon, chlorine or C₁-C₁₈-alkoxy radical,
a is 1, 2 or 3,
b is 4-a,
R⁸, R⁹, R¹⁰ and R¹¹ are each, independently of one another, H or a monovalent unsubstituted or F-, Cl-, OR-, NR₂-, CN- or NCO-substituted C₁-C₁₈-hydrocarbon, chlorine, fluorine or C₁-C₁₈-alkoxy radical, where in each case 2 radicals from among R⁸, R₉, R₁₀ and R¹¹ together with the carbon atoms to which they are bound optionally form a cyclic radical.

9. The process of claim 8, wherein a complex of platinum, iridium or rhodium is used as a catalyst for the hydrosilylation reaction.

10. The process of claim 8, wherein an ionic liquid of the formula (4)
[A]⁺[Y]⁻ (4)
where
[Y]⁻ is an anion selected from the group consisting of [tetrakis(3,5-bis(trifluoromethyl)phenyl)borate] ([BARF]), tetraphenylborate ([13F₄]⁻), hexafluorophosphate ([PF₆]⁻), trispentafluoroethyltrifluorophosphate ([P(C₂F₅)₃F₃]⁻), hexafluoroantimonate ([SbF₆]⁻), hexafluoroarsenate ([AsF₆]⁻), fluorosulfonate, [R′—COO]⁻, [R′—SO₃]⁻, [R′—O—SO₃]⁻, [R′₂—PO₄]⁻, and [(R′—SO₂)₂N]⁻, where R′ is a linear or branched, aliphatic or alicyclic alkyl radical containing from 1 to 12 carbon atoms, a C5-C18-aryl radical or a C5-C18-aryl-C1-C6-alkyl radical whose hydrogen atoms are optionally completely or partly replaced by fluorine atoms, and
[A]⁺ is a cation selected from the group consisting of ammonium cations of the formula (5)
[NR¹R²R³R₄]⁺ (5),
phosphonium cations of the formula (6)
[PR¹R²R³R₄]⁺ (6),
imidazolium cations of the formula (7) 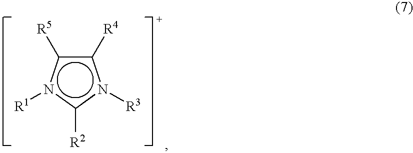
pyridinium cations of the formula (8) 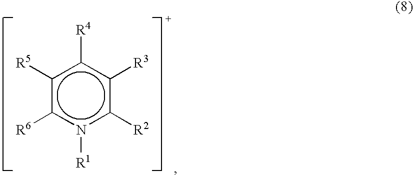
pyrazolium cations of the formula (9) 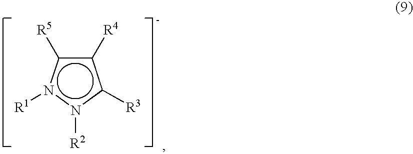
triazolium cations of the formula (10) 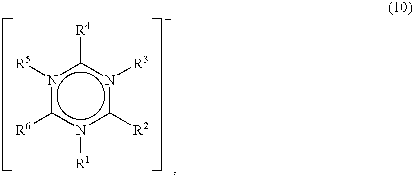
picolinium cations of the formula (11) 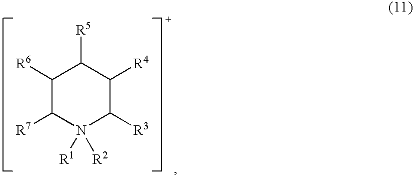
and
pyrrolidinium cations of the formula (12) 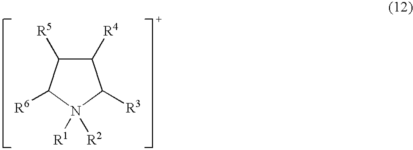
where the radicals R¹⁻⁷ are, in each case independently of one another, organic radicals having 1-20 carbon atoms,
is used as an ionic liquid.

11. The process of claim 9, wherein an ionic liquid of the formula (4)
[A]⁺[Y]⁻ (4)
where
[Y]⁻ is an anion selected from the group consisting of [tetrakis(3,5-bis(trifluoromethyl)phenyl)borate] ([BARF]), tetraphenylborate ([BF₄]⁻), hexafluorophosphate ([PF₆]⁻), trispentafluoroethyltrifluorophosphate ([P(C₂F₅)₃F₃]⁻), hexafluoroantimonate ([SbF₆]⁻), hexafluoroarsenate ([AsF₆]⁻), fluorosulfonate, [R′—COO]⁻, [R′—SO₃]⁻, [R′—O—SO₃]⁻, [R′—PO₄]⁻, and [(R′—SO₂)₂N]⁻, where R′ is a linear or branched, aliphatic or alicyclic alkyl radical containing from 1 to 12 carbon atoms, a C5-C18-aryl radical or a C5-C18-aryl-C1-C6-alkyl radical whose hydrogen atoms are optionally completely or partly replaced by fluorine atoms, and
[A]⁺ is a cation selected from the group consisting of ammonium cations of the formula (5)
[NR¹R²R³R₄]⁺ (5),
phosphonium cations of the formula (6)
[PR¹R²R³R₄]⁺ (6),
imidazolium cations of the formula (7) 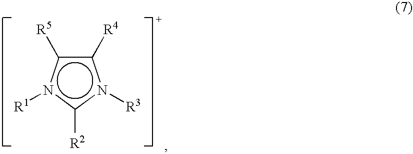
pyridinium cations of the formula (8) 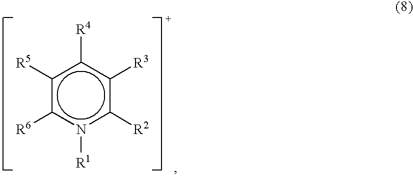
pyrazolium cations of the formula (9) 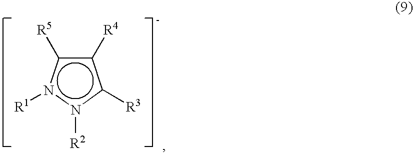
triazolium cations of the formula (10) 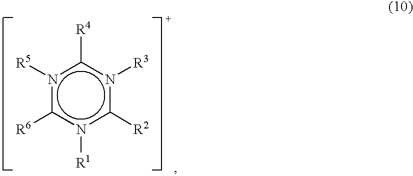
picolinium cations of the formula (11) 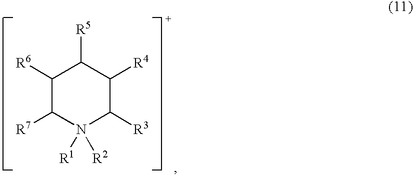
and
pyrrolidinium cations of the formula (12) 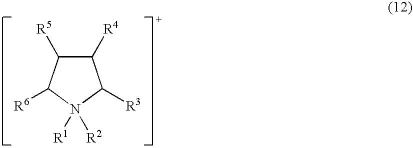
where the radicals R¹⁻⁷ are, in each case independently of one another, organic radicals having 1-20 carbon atoms, is used as an ionic liquid.

12. The process of claim 8, wherein the process is carried out as a two-phase reaction with the catalyst comprising one liquid phase and the reaction products being present as a second liquid phase or a gas phase.

13. The process of claim 8, wherein the catalyst is dissolved in the ionic liquid and is contacted in the reactor with a nonmiscible phase which contains the reaction product at the reactor outlet, so that the ionic catalyst solution is continuously separated by phase separation in the process and recirculated to the reactor.

14. The process of claim 8, wherein a film of the ionic catalyst solution is applied to a support material and the catalyst in this form contacts a reaction mixture in a gas-phase reaction or a liquid-phase reaction.
